(19) United States
(12) Patent Application Publication
(10) Pub. No.: US 2018/0244541 A1
(43) Pub. Date: Aug. 30, 2018

(54) WATER FAUCET HAVING A CAPSULE-BASED FILTER

(71) Applicant: Hamat Sanitary Fittings and Casting Ltd., Ashdod (IL)

(72) Inventor: Shlomo Pirutin, Ashdod (IL)

(73) Assignee: Hamat Sanitary Fittings and Casting Ltd., Ashdod (IL)

(21) Appl. No.: 15/756,062

(22) PCT Filed: Aug. 28, 2016
(86) PCT No.: PCT/IL2016/050942

§ 371 Date: Feb. 28, 2018

Related U.S. Application Data
(60) Provisional application No. 62/211,789, filed on Aug. 30, 2015.

(51) Int. Cl. C02F 1/28; C02F 1/00; B01D 39/06; B01D 35/04

(52) U.S. Cl. CPC C02F 1/283; C02F 1/003; B01D 39/06; B01D 35/04; C02F 2307/06; E03C 2201/40; C02F 2303/02; B01D 2101/02; B01D 2257/2025; B01D 2201/29; B01D 2221/02; C02F 2201/006

(57) ABSTRACT

A water faucet or water tap includes, in its base area or other suitable area or region, a built-in or embedded or integrated filtering mechanism. The filtering mechanism includes a non¬electrical filtering chamber, having a cavity for securing therein a replaceable water-filtering capsule. A suitable water-filtering capsule, having an active filtering component or a passive filtering component, is inserted into the non-electrical filtering chamber, and can be removed from it for periodical replacement. Optionally, the water-filtering capsule includes a scent-producing agent, a flavor-producing agent, or a nutrient or a supplement, which are added to the filtered water. Optionally, a bypass mechanism or water-diverting mechanism enables to select between: a first mode in which a first water-outlet outputs non-filtered mixed hot-and-cold water; and a second mode in which a second water-outlet outputs filtered cold water or filtered room-temperature water.

### CROSS-REFERENCE TO RELATED APPLICATIONS

This patent application claims priority and benefit from U.S. provisional patent application No. 62/211,789, filed on Aug. 30, 2015, which is hereby incorporated by reference in its entirety.

### FIELD OF THE INVENTION

The present invention relates to the field of water faucets and water taps.

### BACKGROUND

A water faucet or water tap is a device able to control the flow of water. A water faucet may allow a user to commence and to stop the flow of water from a plumbing system or from a water-delivery system. A water faucet may further allow a user to modify the pressure of water flow, or the volume of water that flows per time-unit.

Some water faucets may be implemented as a “mixer tap”, for example, featuring a single handle enabling the user to mix hot water supply with cold water supply, to achieve a desired temperature of water that exit the faucet.

### SUMMARY

The present invention may include, for example, a water faucet or water tap which may comprise, in its base area or other suitable area or region, a built-in or embedded filtering mechanism that may utilize an active filter insertable into the filtering mechanism as a replaceable active-filter capsule, which may be replaced or changed by the user (e.g., once a week, twice per month, once per month).

The present invention may provide other and/or additional benefits or advantages.

### BRIEF DESCRIPTION OF THE DRAWINGS

FIG. 1 is a schematic illustration of a water faucet, in accordance with some demonstrative embodiments of the present invention.

FIG. 2 is a schematic illustration of water-filtering capsule, in accordance with some demonstrative embodiments of the present invention.

FIG. 3 is a schematic illustration of a water faucet, in accordance with some demonstrative embodiments of the present invention.

FIG. 4 is a schematic illustration of a water faucet and its base, in accordance with some demonstrative embodiments of the present invention.

FIG. 5 is a schematic illustration of water faucet and its two water outlets, in accordance with some demonstrative embodiments of the present invention.

FIG. 6A is a schematic illustration of another water faucet and its two water outlets, in accordance with some demonstrative embodiments of the present invention.

FIG. 6B is a schematic illustration of an enlarged portion of a water faucet, in accordance with some demonstrative embodiments of the present invention.

FIGS. 7A-7C are schematic illustrations of perspective views of another water faucet, in accordance with some demonstrative embodiments of the present invention.

FIG. 7D is a schematic illustration of a cross-section view of a water faucet, in accordance with some demonstrative embodiments of the present invention.

### DETAILED DESCRIPTION OF THE INVENTION

The term “faucet” or “water faucet” as used herein may include, for example, any suitable faucet or tap or valve that controls the flow of water or other liquids; including, but not limited to, a water faucet intended for installation and utilization in a home, a household, a dwelling, an office, a business venue, a factory, a kitchen, a bathroom, a restroom, indoors, outdoors, and/or other suitable places or venues; such faucet having or utilizing or being controlled by a single handle or single lever, or two handles or two levers, or a knob, or two knobs, or by other user interface elements or controlling elements (e.g., rotating or spinning elements); and including, but not limited to, a pull-out faucet, a pull-down faucet, a single-handle faucet, a double-handle faucet, a bar faucet, a wall mount faucet, a pot filler faucet, a touch-less faucet or hands-free faucet (e.g., activated by sensing a motion of a hand or a gesture of the user), and/or other suitable types of faucets or taps.

Applicants have realized that many consumers avoid drinking water from the kitchen water tap; and that there is a need to provide an efficient, small-form-factor, mechanism and solution to enhance and/or improve and/or filter tap water, in a user-friendly manner

Applicants have realized that there exist some conventional systems that are big, bulky, cumbersome, expensive, and require electric power, typically requiring a bulky container that needs to be installed under the kitchen sink or under the countertop, takes up storage space under the sink, and performs purification of water in a cumbersome process. Such conventional water purifying system requires regular and/or periodic maintenance by a professional technician, regular and/or periodic cleaning, replacement of parts of the purification system (e.g., UV light), as well as requiring the presence of a professional technician in order to maintain such cumbersome system(s). Additionally, such a system, if not properly maintained, may actually cause or trigger growth of bacteria or mold or parasites, thereby causing an adverse effect of polluting the water instead of purifying the water.

In accordance with the present invention, a water faucet may be manufactured, or may be modified or augmented or configured to include, an embedded member or mechanism that is able to filter the water that pass through the water faucet, by utilizing one or more active filter(s) and/or passive filter(s) or other filtering element(s) that are provided into, and fit into, the embedded member as a replaceable capsule or filter-capsule or filtering-capsule.

In accordance with the present invention, a filtering chamber may be embedded in the base or in the base-area or in the base-region of the faucet, which is visible over and is located over a conventional kitchen countertop or over a conventional sink; such that the filtering chamber is not located under the kitchen countertop, and such that the filtering chamber is autonomous and does not require (and does not utilize, and does not cooperate with) a filtering device that is conventionally bulky and cumbersome and is located under the sink or under the countertop.

In accordance with some demonstrative embodiments of the present invention, the entirety of the filtering mechanism and the filtering chamber, as well as the replaceable filtering capsule, is located upwardly from the kitchen countertop, within or near the base of the water faucet, and not along the generally-vertical main pipe or main tube of the water faucet, and not located at (and not located near, and not embedded with) the actual outlet or outlet-area of the water faucet (e.g., the actual opening through which the water flows out, optionally having there a simple, conventional, mesh filter). In other demonstrative embodiments of the present invention, some or all or part of the filtering mechanism, may optionally be located at the same level of the sink or at the same level of the countertop; or may be located, partially or entirely, below the sink level or below the countertop. Other suitable implementations may be achieved, in accordance with the present invention.

In accordance with some demonstrative embodiments of the present invention, a water faucet or an integrated pull-down water faucet may comprise an embedded active charcoal filter, in a replaceable filtering capsule. Optionally, the filtering capsule may actively filter all the water that flow through the faucet; or only the cold water; or only the hot water; or both the hot and cold water; or the mixed of hot-and-cold water. In some demonstrative embodiments of the present invention, only cold water (or only room-temperature water, or only non-hot water) may pass through the filtering chamber that is embedded in the water faucet; while hot water may not pass through that filtering chamber; and optionally, a button or switch or lever or other User Interface (UI) element or controller (e.g., mechanical element, knob, lever, switch, button) may be used in order to enable the user to selectively command the water faucet to pour out either (a) filtered cold water, or (b) non-filtered water (e.g., which may be hot water, or warm water, or mixture of hot and cold water as controlled by the lever or knob or the water faucet mixing mechanism). The selection may be implemented by using a diverter element, a bypass element, a mechanical switching element, an A/B mechanical switch, or the like. In other demonstrative embodiments, all or substantially all of the water that flow through the water faucet (e.g., cold water and/or hot water, or a mixture thereof) may pass through the filtering chamber and/or may be filtered. Other suitable implementations may be used.

In some embodiments, the faucet may be configured to have two (or more) water channels: a first water channel (or water flow path or tubing) that is dedicated to filtered water (e.g., to cold or non-hot filtered water, or to room-temperature filtered water); and second water channel (or water flow path or tubing) that is dedicated to mixed water (which may be non-filtered; or may be filtered, depending on the implementation).

The present invention may provide a kitchen faucet having a replaceable filter-capsule to purify and/or disinfect and/or filter the water; by utilizing only a stand-alone, autonomous, water tap (water faucet), without a need for electricity and without a need for an accompanying device or cumbersome and bulky water purification system.

In some embodiments, the filtering capsule may comprise one or more charcoal filter(s), or other active water-filtering elements. In some embodiments, the capsule is intended to be replaced weekly, or by-weekly, or monthly, or daily.

In some embodiments, optionally, the filtering capsule may further comprise one or more agents or materials or edible materials, that may provide particular flavor and/or taste to the tap water being filtered, and/or that may provide particular scent or aroma or odor to the tap water being filtered; for example, lemon or lemonade flavor and/or odor, orange flavor and/or odor, ginger flavor and/or odor, or the like.

In some embodiments, optionally, the filtering capsule may further comprise one or more agents or materials or edible materials, that may provide supplements and/or vitamins and/or minerals and/or supplements and/or nutrients and/or other materials which may be added to the filtered water; for example, releasing small amounts of Vitamin C or Calcium or other materials or additive or nutrients into the water being filtered.

In some embodiments of the present invention, optionally, the filtering capsule may be replaced with a capsule that does not filter the water, but rater, only adds to the tap water the desired flavor and/or odor and/or supplements and/or nutrients; thereby utilizing the capsule chamber for an alternate purpose, of adding additives to the water instead of filtering the water. In other embodiments, optionally, the filtering capsule may provide dual-functionality or triple-functionality or multiple-functionality, by providing active filtering and/or flavor-adding and/or scent-adding and/or supplements-adding.

In accordance with some demonstrative embodiments of the present invention, the capsule filter may comprise a charcoal filter or an active charcoal filter, able to filter-out or purify the tap water from dirt, chlorine, and/or other non-desired elements or materials; and able to make the tap water tastier to drink, and able to provide a fresher taste to tap water. In some embodiments, the filtering capsule may be inserted and removed easily and efficiently, by a non-professional user.

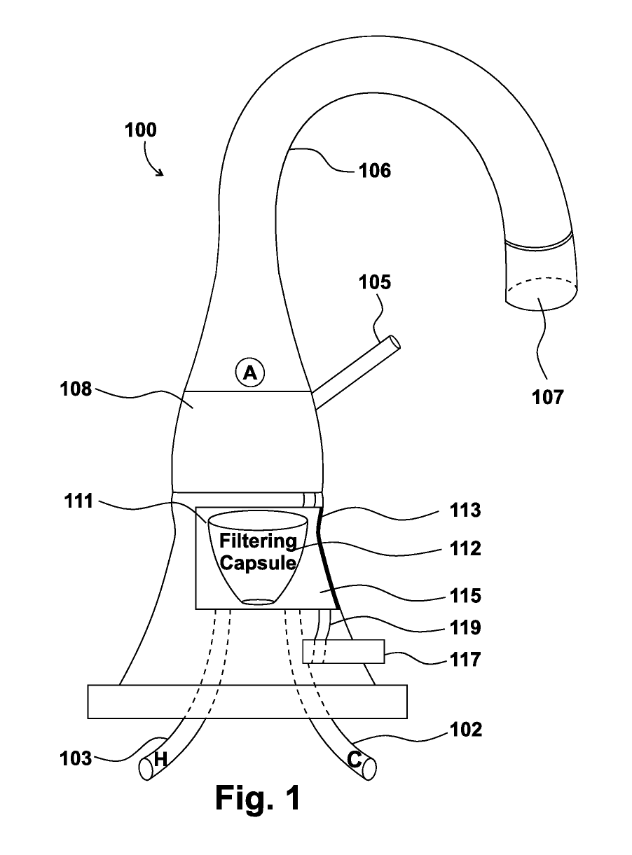

Reference is made to FIG. 1, which is a schematic illustration of a water faucet 100, in accordance with some demonstrative embodiments of the present invention. Water faucet 100 may comprise a base 104 (or base-region, or base-component, or dome, or cylinder, or the like), able to be connected to (or installed on, or installed in, or attached to) a top surface 101 (e.g., a top surface of a counter-top, or a top surface of a marble slab, or a top surface of an artificial stone slab, or a top surface of a sink).

Water faucet 100 may receive one or more incoming flows of water, through one or more incoming water tubes or pipes; for example, incoming cold water pipe 102, and/or incoming hot water pipe 103. A handle 105 or other lever or User Interface (UI) component (e.g., knob, knobs, multiple handles, multiple levers, or the like) may enable the user to operate a mixer and flow regulator 108, which may mix the incoming water flows based on the rate and/or flow-pressure as controlled via the handle 105. The mixed water is outputted via the top-side water tube 106, and exits (e.g., downwardly towards a sink) via a water outlet 107.

In accordance with the present invention, the base 104 of the water faucet 100 may comprise a non-electrical filtering chamber 111, having a cavity 115 into which a replaceable water-filtering capsule 112 may be inserted. Optionally, a cover 113 (e.g., rotating on a hinge, or peel-able, or sliding cover, or male-female removable cover) may cover the cavity 115 and/or may secure the water-filtering capsule 112 into its place.

In some embodiments, at least one of the incoming water flows, such as, at least the cold water flow, is filtered by the non-electrical filtering chamber 111 and the water-filtering capsule 112 located therein. In other embodiments, the non-electrical filtering chamber 111 and the water-filtering capsule 112 located therein may alternately be located at an alternate location of the water faucet, denoted with “A” in FIG. 1, such that the already-mixed water flow (or the post-mixture water flow) is being filtered; in addition to, or instead of, filtering the pre-mixed flow of water or the pre-mixed flow of only a single flow of water (e.g., only the cold water).

The base 104 may comprise suitable pipes, tubes and water-delivery components or water diverting components, to allow the incoming water flow(s) to pass through the non-electrical filtering chamber 111 and particularly to pass through (or to be in touch with) the water-filtering capsule 112 located therein, prior to being mixed and/or outputted from the water faucet 100.

Optionally, a filter bypass switch 117 or other User Interface (UI) element (e.g., button, mechanical switch, diverter, push-pull button, pin, or the like) may enable the user to select between at least two modes of operation: (I) a first mode of operation, in which the water passes through the through the non-electrical filtering chamber 111 and particularly pass through (or to be in touch with) the water-filtering capsule 112 located therein; and (II) a second mode of operation, in which a bypass mechanism 119 is actuated or is activated by the filter bypass switch, thereby causing the water flow(s) to be diverted around the through the non-electrical filtering chamber 111 and to bypass the non-electrical filtering chamber 111, thereby bypassing also the water-filtering capsule 112.

In some embodiments, only the water-filtering capsule is removable or replaceable, whereas the non-electrical filtering chamber 111 remains secured and permanently attached to the base 104. In other embodiments, an entirety of the non-electrical filtering chamber 111 may be removable from the base 104, in order to allow cleaning of the non-electrical filtering chamber 111, and/or in order to enable replacement of the water-filtering capsule externally from (or away from) the base 104.

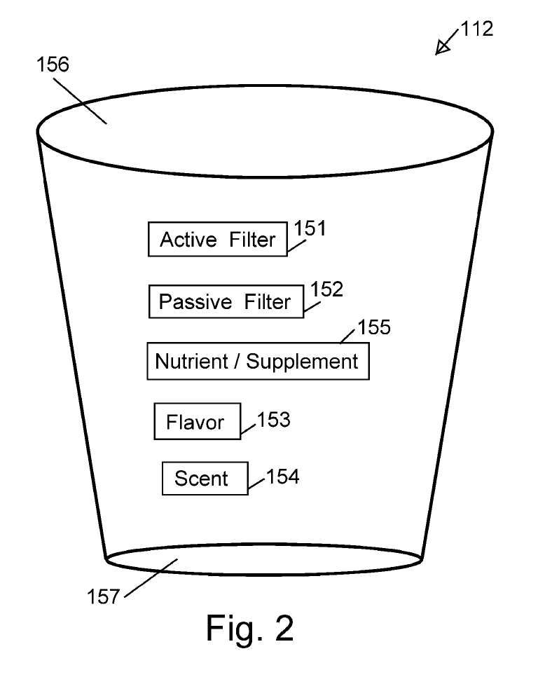

Reference is made to FIG. 2, which is a schematic illustration of water-filtering capsule 112, in accordance with some demonstrative embodiments of the present invention. Water-filtering capsule 112 may comprise one or more, or some, of the following units or components: an active filter 151 (e.g., active charcoal filter); a passive filter 152; a flavor-adding agent 153; a scent-adding agent 154; a nutrient or supplement adding agent 155; and/or other suitable components.

In some embodiments, a top surface 156 of water-filtering capsule 112 may be generally circular or oval or elliptical, or may have other suitable shape. The top surface 156 may be formed from a suitable material or by using a suitable structure, that keeps the content of water-filtering capsule 112 within the capsule 112 and does not allow such content to leak from (or to exit from) the capsule 112; while also allowing a stream of water to pass through the capsule 112, and particularly to pass (e.g., uni-directionally) from within the capsule 112 and through the top surface 156 towards a water outlet of the water faucet.

In some embodiments, a bottom surface 157 of water-filtering capsule 112 may be generally circular or oval or elliptical, or may have other suitable shape. The bottom surface 157 may be formed from a suitable material or by using a suitable structure, that keeps the content of water-filtering capsule 112 within the capsule 112 and does not allow such content to leak from (or to exit from) the capsule 112; while also allowing a stream of water to pass through the capsule 112, and particularly to pass (e.g., uni-directionally) from an incoming non-filtered stream of water, through bottom surface 156 of the capsule 112, then through the content of capsule 112 (e.g., or while touching or being in touch or being in direct proximity to such content), and then exiting the capsule 112 through the top surface 156 towards a water outlet of the water faucet.

In some embodiments, optionally, the bottom surface 157 of the capsule 112 may comprise, or may be implemented by using, a uni-directional mesh or net or fabric or paper or thin barrier or membrane, which allows non-filtered water to enter into the capsule 112 (e.g., uni-directionally) through the bottom surface 157.

In some embodiments, optionally, the top surface 156 of the capsule 112 may comprise, or may be implemented by using, a uni-directional mesh or net or fabric or paper or thin barrier or membrane, which allows filtered water to exit from the capsule 112 (e.g., uni-directionally) through the top surface 156.

In some embodiments, one or more Sealing O-ring(s) on the filter may be injected with the filter body and/or with the capsule 112, to prevent the need to utilize a separate O-ring or sealant that may be left or that falls during filter replacement. In some embodiments, the water-filtering capsule 112 may integrally comprise an O-ring, that may be pre-provided as integral part of the capsule (e.g., injected via injection molding at the external side of the water-capsule), such as externally to the capsule 112, or circling or encircling the top surface 156 and/or the bottom surface 156 and/or the side-walls of the capsule 112; thereby providing the end-user with an integral or integrated solution in which the water-filtering capsule integrally comprises an O-ring to reduce or minimize leaks, and obviating the need for the end-user to handle separately an O-ring or other sealing component or other leakage-prevention component (which may otherwise fall or get lost or move, inadvertently).

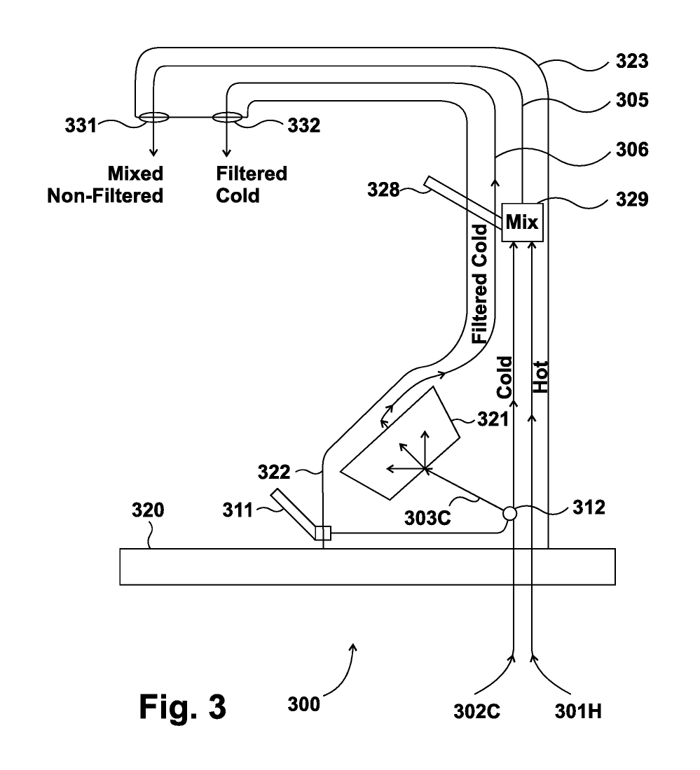

Reference is made to FIG. 3, which is a schematic illustration of a water faucet 300, in accordance with some demonstrative embodiments of the present invention. Water faucet 300 may comprise a base 322 which may be installed or mounted over or onto a top-surface 320. Water faucet 300 may include, or may be connected to, two or more incoming water flows or water pipes or water tubes; for example, a hot water flow 301H, and a cold water flow 302C.

The hot water flow 301H and the cold water flow 302C may be mixed and/or may be pressure-regulated, by a mixer and flow regulator unit 329, which is controlled by a handle 328 or other lever or knob or User Interface (UI) element that is operated by the user; and which produces and outputs a flow of mixed (non-filtered) water 305, which then exits the water faucet through a first water-outlet 331 of a top tube 323 of the water faucet 300.

Additionally or alternatively, a water diverter 312 or other water-divider or flow-splitter component, may be actuated or activated by the user (e.g., via an actuator or a secondary handle 311, or a button or a mechanical switch), thereby diverting the incoming cold water flow 302C into a secondary cold water flow 303C towards a water-filtering capsule 321 located within the water faucet 300 (e.g., located within the base 322, located vertically above the top surface 320). The cold water flow 303C passes through the water-filtering capsule 321, which in turn outputs a filtered cold water flow 306; which then exits the water faucet via a second water-outlet 332.

Other suitable structures and flows may be used, to maintain separate flows and separate channels for (i) filtered water, and (ii) non-filtered water.

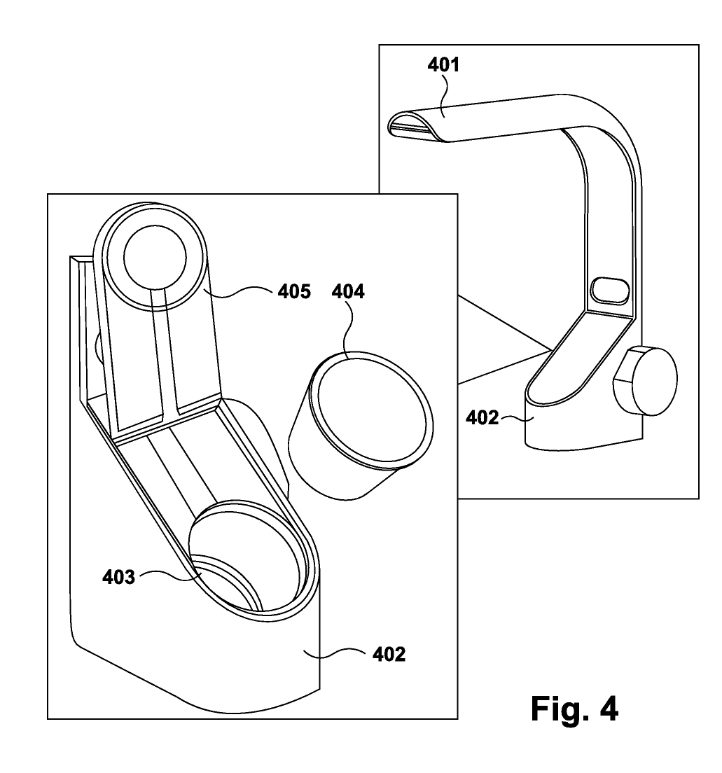

Reference is made to FIG. 4, which is a schematic illustration of a water faucet 401 and its base 402, in accordance with some demonstrative embodiments of the present invention. The base 402 is further shown in a zoomed-in or enlarged view; demonstrating an open-state of a cover 405, of a cavity 403 of the water filtering chamber, into which a water-filtering capsule 404 may be inserted.

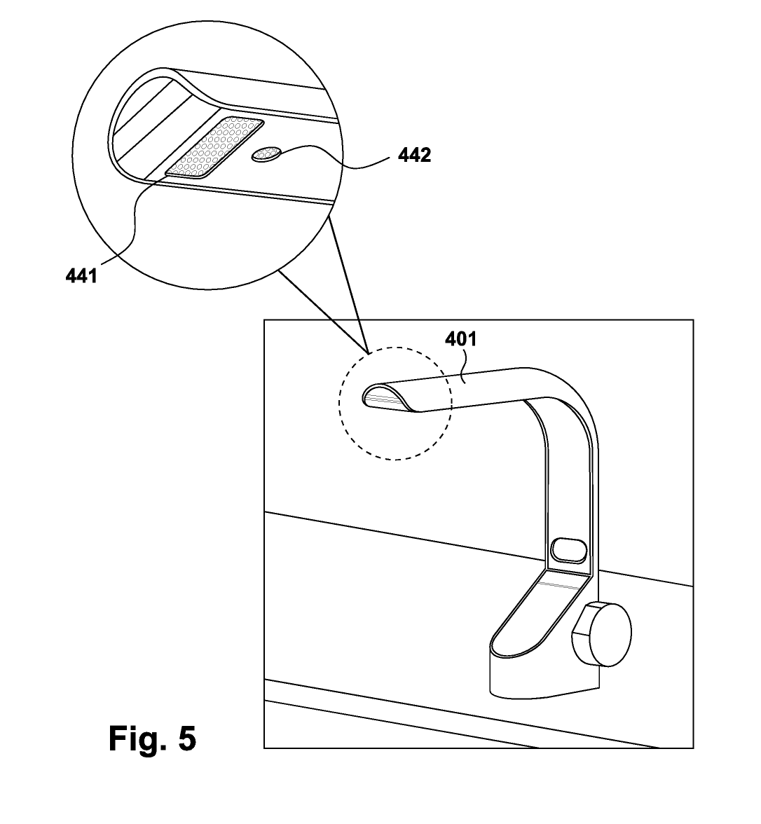

Reference is made to FIG. 5, which is a schematic illustration of water faucet 401 and its two water outlets, in accordance with some demonstrative embodiments of the present invention. For example, a water outlet 441 may output non-filtered mixed tap water; whereas a separate and nearby water outlet 442 may output filtered cold water (or, filtered room-temperature water). A diverter or bypassing mechanism may be actuated by the user, to select between the two modes of operation or between the two types of water outputs that the water faucet 401 is able to produce.

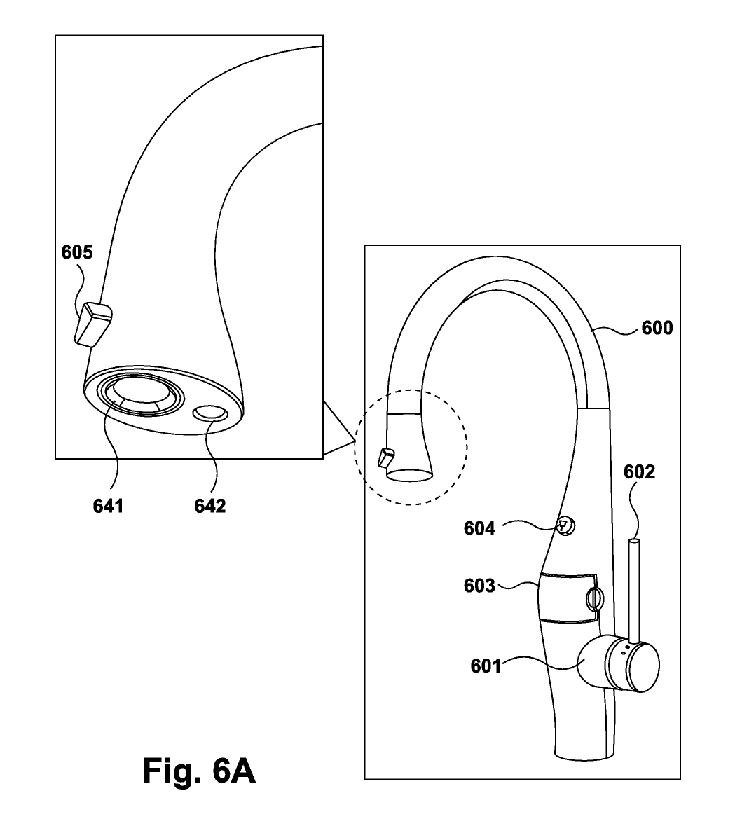

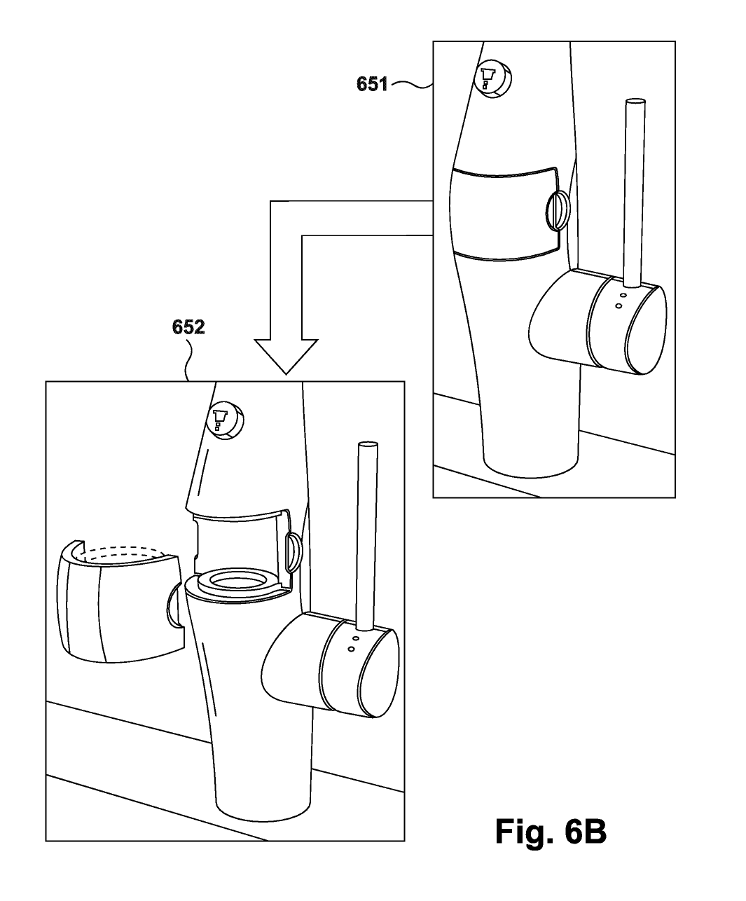

Reference is made to FIG. 6A, which is a schematic illustration of another water faucet 600 and its two water outlets, in accordance with some demonstrative embodiments of the present invention. For example, a water outlet 641 may output non-filtered mixed tap water; whereas a separate and nearby water outlet 642 may output filtered cold water (or, filtered room-temperature water). Optionally, a water filtering chamber 603 (into which a replaceable water-filtering capsule is inserted) may be located above or upwardly relative to a mixing and water-pressure regulator unit 601 that is manually controlled by a handle 602. Optionally, a diverter switch 604 and/or a diverter switch 605, may be utilized by the user in order to select between output of (I) non-filtered mixed tap water, or (II) filtered cold water (or, filtered room-temperature water).

Reference is also made to FIG. 6B, which is a schematic illustration of an enlarged portion of the water faucet 600, in accordance with some demonstrative embodiments of the present invention; demonstrating a closed position 651 in which the water-filtering chamber is closed and is secured within the body (or the base) of the faucet 600; and further demonstrating an open position 652 (or a removed position), in which the water-filtering chamber is removed from the faucet 600, e.g., for cleaning and/or for replacing the water-filtering capsule that is held therein.

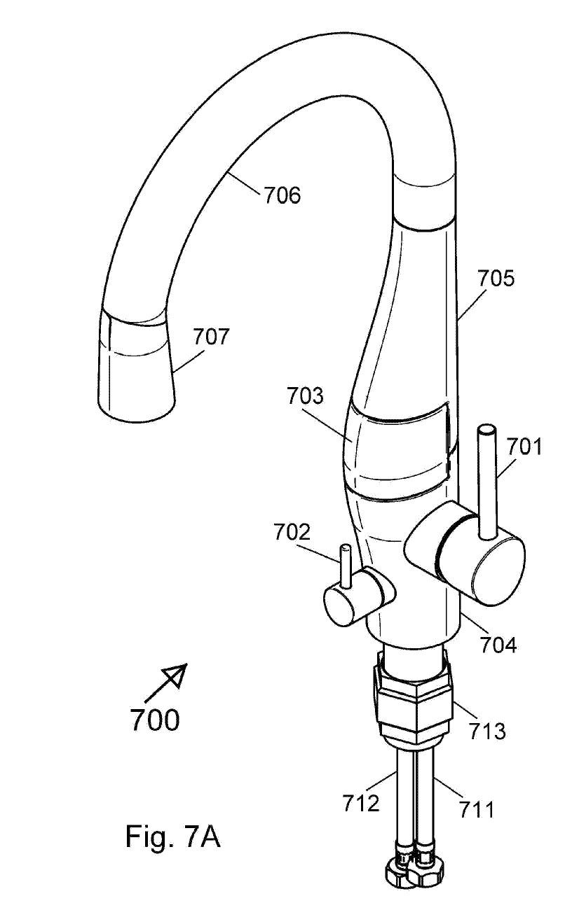

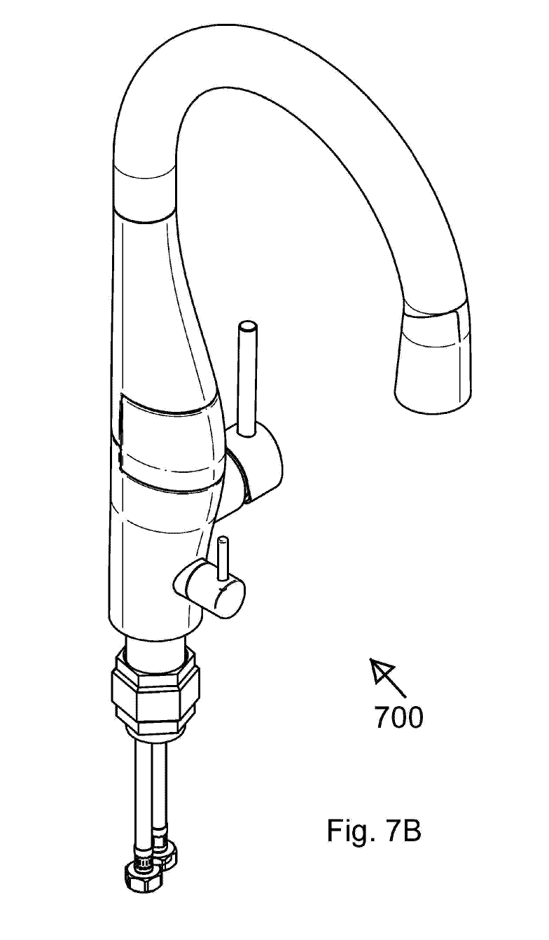

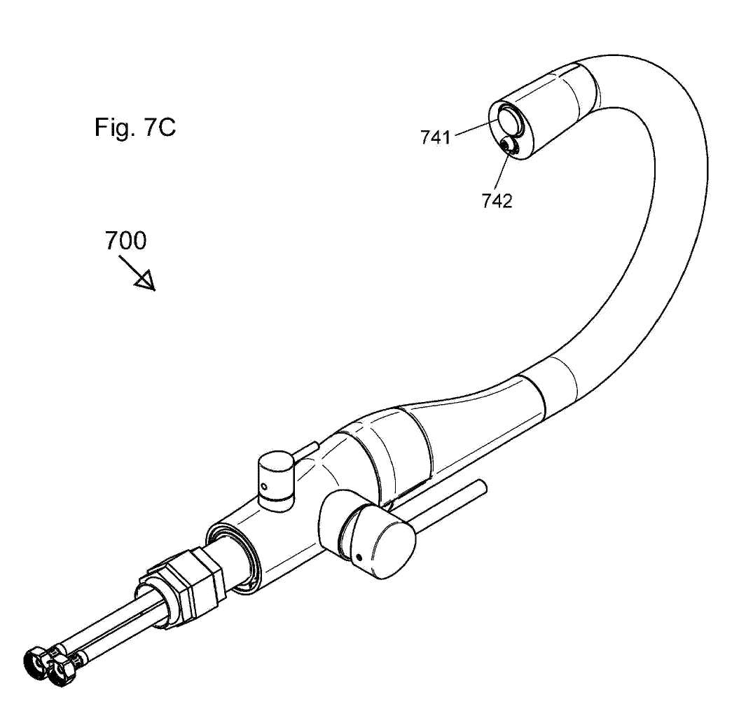

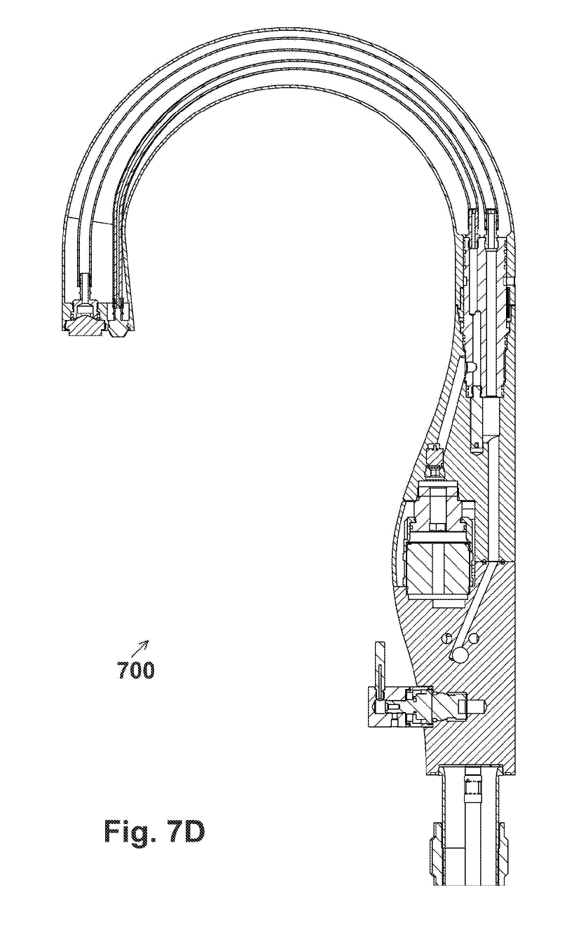

Reference is made to FIGS. 7A-7C, which are schematic illustrations of perspective views of another water faucet 700, in accordance with some demonstrative embodiments of the present invention. Reference is also made to FIG. 7D, which is a schematic illustration of a cross-section view of water faucet 700, in accordance with some demonstrative embodiments of the present invention.

A base 704 may be connected to (or mounted on, or installed in) a top surface (e.g., of a countertop or a sink), via a connection mechanism 713. The water faucet 700 may receive an incoming hot water flow via an incoming hot water tube 711; and may receive an incoming cold water flow (or, incoming room-temperature water flow) via an incoming cold water tube 712.

A primary handle 701 may control a primary mixing and flow regulation unit, enabling the user to control the mixing ratio and the water pressure of mixed, non-filtered, hot water and cold water. The mixture of hot and cold water may internally bypass around the filtering chamber 703, and may proceed to exit the water faucet 705 via a generally-vertical pipe 705 and a curved pipe 706, through a primary water-outlet 741 of a water outlet assembly 707 which may be fixed or may be a pull-down component (e.g., having an extendable and retractable, flexible, tube).

A secondary handle 702 may be integral to the water faucet 700, or particularly to its base 704, and may enable a user to control and regulate the flow of filtered cold water (or, filtered room-temperature water). For example, upon engaging the secondary handle 702, only cold water (or, only room-temperature water) may flow internally towards the filtering chamber 703; and may be filtered therein via the replaceable water-filtering capsule. The filtered cold water (or, the filtered room-temperature water) may then proceed to exit the water faucet 705 via the generally-vertical pipe 705 and the curved pipe 706, through a secondary water-outlet 742 of the water outlet assembly 707 which may be fixed or may be a pull-down component (e.g., having an extendable and retractable, flexible, tube).

Embodiments of the present invention may be used in conjunction with any type of faucet or water faucet. In some embodiments, the manual selection or the manual switching between (i) non-filtered mixed (hot and cold) water, and (ii) filtered cold-only water (or, filtered room-temperature water; or filtered non-mixed water), may be implemented by using a secondary handle or secondary lever, and/or by using a diverter switch or diverter button or diverter mechanism, and/or by using a bypass switch or bypass button or bypass mechanism, and/or by other suitable means. In some implementation, the entire faucet may include a single handle or a single lever, which may be used (by itself, or optionally in combination with a push-button or a switch or other mechanical selection or diversion or bypass mechanism) to enable user selection between (i) non-filtered mixed (hot and cold) water, and (ii) filtered cold-only water (or, filtered room-temperature water; or filtered non-mixed water),

The present invention may provide a high-end, modern filter faucet that may replace the various cumbersome filtering accessories and devices in the kitchen, and/or may further replace the utilization of pre-bottled water, or water delivered in heavy containers to homes or offices.

In some implementations, a replaceable water-filtering capsule filters the water (e.g., only the cold water; or, only the room-temperature water; or, the mixed hot-and-cold water) within the water-faucet, within a filtering chamber that is located higher (vertically) relative to a counter-top or relative to a top surface of a sink. The filter replacement operation may be user-friendly, quick and easy, and is performed rapidly by the end-user (e.g., once a month, or once a week), and does not require a professional technician. The filter capacity may be, for example, the ability to filter at least 50 or 60 or 80 or 100 liters of water; or, the ability to filter at least 50 or 60 or 80 or 100 liters of water per week; or, the ability to filter at least 200 or 250 or 300 or 400 liters of water per month. Other suitable ranges or values may be used.

In some embodiments, the removable water-filtering capsule, is the only component of the water faucet that is removable or detachable from the water-faucet. In other embodiments, the water-filtering chamber (in which the water-filtering capsule is placed), as well as the water-filtering capsule that is placed therein, are the two only components of the water faucet that are removable (e.g., together as a single unit) or detachable from the water-faucet. In some embodiments, no other parts of the water-faucet are removable and/or detachable from the water-faucet, except for the water-filtering capsule and/or (optionally) the water-filtering chamber that hosts and holds the capsule therein. Optionally, a cover or lead may be used, to ensure that the water-filtering capsule is securely held within the water-filtering chamber within the faucet, and/or to ensure that the water delivery system or the water routing system within the water-faucet does not cause splashing of water externally to the faucet.

In some embodiments, optionally, a “click” sound or other sound or other audible feedback, may be produced upon the correct or the precise insertion of the water-filtering capsule into its holding place in the water-filtering chamber, and/or upon the correct and precise insertion of the water-filtering chamber into its place in the water faucet; thereby providing audible feedback to the end-user that the filter replacement was correctly performed. In some embodiments, the audible feedback may be accompanied by a tactile feedback, such as a mechanical “click” or “snap” action that is successfully performed, indicating to the end-user via tactile feedback that the replacement or the insertion are performed successfully.

Optionally, a non-return valve, or other one-way water delivery mechanism, may be utilized and located about the filtering chamber (e.g., at or near the bottom of the spout), to avoid dripping or exiting of water during filter replacement.

Optionally, a damper implementation may be used, with a vertical sealing. For example, the damper may be stretched during normal work with the cover or door closed, and may be released during filter replacement when the cover or door is open. Closed cover indicates that the filter is completely sealed and secured in its place. In some implementations, the cover need be disconnected from the body of the water faucet, and may only open to the side (e.g., sliding to the side, or rotating via a hinge; for example, using a single door cover solution, having an hinge on the left side of the body of the water faucet, away from the handle). Optionally, a small amount of force may be applied by the end-user to open the cover of the filtering chamber; and a positive “click” or “snap”, accompanied by an audible feedback and/or tactile feedback, may indicate to the user that correct and complete closing of the cover has occurred.

In some embodiments, the filtering chamber and/or the water-filtering capsule can be produced to withstand at least 1.5 or 2.0 or 2.5 bar pressure, without the need for a special housing to protect them.

In some embodiments, one or more suitable mechanisms may be utilized in order to reduce accumulation of dirt or lime or bacteria, at or near the connecting edges of the cover and the body of the water-faucet, or at (or near, or within) the filtering chamber. Optionally, an anti-bacterial agent and/or a cleansing agent may be used or placed therein or thereon.

In accordance with some embodiments of the invention, a water faucet comprises: one or more incoming water inlets, to receive at least a first flow of incoming water; a base connectable to a surface of a countertop or a sink; a handle to control a flow of water that exit the water faucet; an outlet water tube to output the water that exit the water faucet; a non-electrical (or non-electric; or non electrically powered) filtering chamber, that is integral to said water faucet, and is located upwardly relative to said surface of the countertop or the sink; wherein the filtering chamber comprises a cavity to accommodate a replaceable filtering capsule; wherein the filtering chamber, when storing therein said replaceable filtering capsule, operates (i) to filter said at least first flow of incoming water, and (ii) to output filtered water towards said outlet water tube.

In some embodiments, the non-electrical filtering chamber and the replaceable filtering capsule operate and filter said flow of incoming water without utilizing any electric power.

In some embodiments, the non-electrical filtering chamber comprises said cavity to accommodate said replaceable filtering capsule which comprises an active filtering component selected from the group consisting of: carbon, active charcoal.

In some embodiments, the non-electrical filtering chamber comprises said cavity to accommodate said replaceable filtering capsule which comprises a passive filtering component.

In some embodiments, the non-electrical filtering chamber is located integrally within said base of the water faucet.

In some embodiments, the non-electrical filtering chamber is located integrally within said base of the water faucet; wherein an entirety of the non-electrical filtering chamber is detachable and removable from said base of the water faucet; wherein the replaceable filtering capsule is replaceable only when said entirety of the non-electrical filtering chamber is removed from said base of the water faucet.

In some embodiments, the non-electrical filtering chamber and the removable filtering capsule, operate to filter only a flow of cold water.

In some embodiments, the non-electrical filtering chamber and the removable filtering capsule, operate to filter a mixture of cold water and hot water.

In some embodiments, the water faucet comprises: a first water channel that is internal to said water faucet, and that routes only cold water into and through the non-electrical filtering chamber and the removable filtering capsule, which output filtered cold water that exit the water faucet through a first water-outlet that exclusively outputs filtered cold water; a second water channel that is internal to said water faucet, and that routes mixed non-filtered cold water and hot water that bypass said non-electrical filtering chamber and that exit the water faucet through a second water-outlet that exclusively outputs non-filtered mixed hot-and-cold water.

In some embodiments, the water faucet comprises: a first water channel that is internal to said water faucet, and that routes only cold water into and through the non-electrical filtering chamber and the removable filtering capsule, which output filtered cold water that exit the water faucet through a first water-outlet that exclusively outputs filtered cold water; a first handle to control water flow of the first water channel; a second water channel that is internal to said water faucet, and that routes mixed non-filtered cold water and hot water that bypass said non-electrical filtering chamber and that exit the water faucet through a second water-outlet that exclusively outputs non-filtered mixed hot-and-cold water; a second handle to control water flow of the second water channel.

In some embodiments, the water faucet comprises: a first water channel to deliver a mixture of non-filtered cold water and non-filtered hot water, which exit the water faucet through a first water-outlet; a second water channel to divert only non-filtered cold water into the non-electrical filtering chamber, and to receive from the non-electrical filtering chamber a flow of filtered cold water, which exit the water faucet through a second, separate, water-outlet; a mechanical actuator to enable a user to selectively output from the water faucet, (I) non-filtered mixture of cold water and hot water, or (II) filtered cold water.

In some embodiments, the water faucet comprises: a diverter switch that enables a user to selectively modify a mode of operation of the water faucet, between at least the following modes of operation: (I) a first mode of operation in which water is filtered via the non-electrical filtering chamber and the removable filtering capsule; (II) a second mode of operation in which water is not filtered via the non-electrical filtering chamber and the removable filtering capsule.

In some embodiments, the non-electrical filtering chamber comprises said cavity to accommodate said replaceable filtering capsule which further comprises at least one of: a flavor-producing agent that adds a particular flavor to the water being filtered; a scent-producing agent that adds a particular scent to the water being filtered; a nutrient that is added to the water being filtered; a dietary supplement that is added to the water being filtered.

In some embodiments, an apparatus comprises: a water-filtering capsule, that is insertable into and is removable from a non-electrical (or non-electric, or non electrically powered) filtering chamber of a water faucet; wherein the water-filtering capsule is replaceable, and operates to filter water that flow within said water faucet at a point that is vertically higher relative to a surface of a sink or a countertop on which said water faucet is connected. In some embodiments, the non-electrical filtering chamber and the water-filtering capsule operate and filter water without utilizing any electric power. In some embodiments, the water-filtering capsule comprises an active filtering component selected from the group consisting of: carbon, active charcoal. In some embodiments, the water-filtering capsule comprises a passive filtering component. In some embodiments, the water-filtering capsule comprises at least one of: a flavor-producing agent that adds a particular flavor to the water being filtered; a scent-producing agent that adds a particular scent (or odor, or aroma, or smell) to the water being filtered; a nutrient that is added to the water being filtered; a dietary supplement that is added to the water being filtered. In some embodiments, the water-filtering capsule integrally comprises an O-Ring to prevent water leakage; wherein the O-Ring and the water-filtering capsule are a single injected-molding article.

The present invention may provide a water faucet or water tap which includes, in its base area or other suitable area or region, a built-in or embedded or integrated filtering mechanism. For example, the filtering mechanism includes a non-electrical filtering chamber, having a cavity for securing therein a replaceable water-filtering capsule. A suitable water-filtering capsule, having an active filtering component or a passive filtering component, is inserted into the non-electrical filtering chamber, and can be removed from it for periodical replacement. Optionally, the water-filtering capsule includes a scent-producing agent, a flavor-producing agent, or a nutrient or a supplement, which are added to the filtered water. Optionally, a bypass mechanism or water-diverting mechanism enables to select between: a first mode in which a first water-outlet outputs non-filtered mixed hot-and-cold water; and a second mode in which a second water-outlet outputs filtered cold water or filtered room-temperature water.

Functions, operations, components and/or features described herein with reference to one or more embodiments, may be combined with, or may be utilized in combination with, one or more other functions, operations, components and/or features described herein with reference to one or more other embodiments, or vice versa.

While certain features of some embodiments have been illustrated and described herein, many modifications, substitutions, changes, and equivalents may occur to those skilled in the art. Accordingly, the claims are intended to cover all such modifications, substitutions, changes, and equivalents.

What is claimed is:

1. A water faucet comprising:
one or more incoming water inlets, to receive at least a first flow of incoming water;
a base connectable to a surface of a countertop or a sink;
a handle to control a flow of water that exit the water faucet;
an outlet water tube to output the water that exit the water faucet;
a non-electrical filtering chamber, that is integral to said water faucet, and is located upwardly relative to said surface of the countertop or the sink;
wherein the filtering chamber comprises a cavity to accommodate a replaceable filtering capsule;
wherein the filtering chamber, when storing therein said replaceable filtering capsule, operates (i) to filter said at least first flow of incoming water, and (ii) to output filtered water towards said outlet water tube.

2. The water faucet of claim 1, wherein the non-electrical filtering chamber and the replaceable filtering capsule operate and filter said flow of incoming water without utilizing any electric power.

3. The water faucet of claim 1, wherein the non-electrical filtering chamber comprises said cavity to accommodate said replaceable filtering capsule which comprises an active filtering component selected from the group consisting of: carbon, active charcoal.

4. The water faucet of claim 1, wherein the non-electrical filtering chamber comprises said cavity to accommodate said replaceable filtering capsule which comprises a passive filtering component.

5. The water faucet of claim 1, wherein the non-electrical filtering chamber is located integrally within said base of the water faucet.

6. The water faucet of claim 1, wherein the non-electrical filtering chamber is located integrally within said base of the water faucet;
wherein an entirety of the non-electrical filtering chamber is detachable and removable from said base of the water faucet;
wherein the replaceable filtering capsule is replaceable only when said entirety of the non-electrical filtering chamber is removed from said base of the water faucet.

7. The water faucet of claim 1, wherein the non-electrical filtering chamber and the removable filtering capsule, operate to filter only a flow of cold water.

8. The water faucet of claim 1, wherein the non-electrical filtering chamber and the removable filtering capsule, operate to filter a mixture of cold water and hot water.

9. The water faucet of claim 1, comprising:
a first water channel that is internal to said water faucet, and that routes only cold water into and through the non-electrical filtering chamber and the removable filtering capsule, which output filtered cold water that exit the water faucet through a first water-outlet that exclusively outputs filtered cold water;
a second water channel that is internal to said water faucet, and that routes mixed non-filtered cold water and hot water that bypass said non-electrical filtering chamber and that exit the water faucet through a second water-outlet that exclusively outputs non-filtered mixed hot-and-cold water.

10. The water faucet of claim 1, comprising:
a first water channel that is internal to said water faucet, and that routes only cold water into and through the non-electrical filtering chamber and the removable filtering capsule, which output filtered cold water that exit the water faucet through a first water-outlet that exclusively outputs filtered cold water;
a first handle to control water flow of the first water channel;
a second water channel that is internal to said water faucet, and that routes mixed non-filtered cold water and hot water that bypass said non-electrical filtering chamber and that exit the water faucet through a second water-outlet that exclusively outputs non-filtered mixed hot-and-cold water;
a second handle to control water flow of the second water channel.

11. The water faucet of claim 1, comprising:
a first water channel to deliver a mixture of non-filtered cold water and non-filtered hot water, which exit the water faucet through a first water-outlet;
a second water channel to divert only non-filtered cold water into the non-electrical filtering chamber, and to receive from the non-electrical filtering chamber a flow of filtered cold water, which exit the water faucet through a second, separate, water-outlet;
a mechanical actuator to enable a user to selectively output from the water faucet, (I) non-filtered mixture of cold water and hot water, or (II) filtered cold water.

12. The water faucet of claim 1, further comprising:
a diverter switch that enables a user to selectively modify a mode of operation of the water faucet, between at least the following modes of operation:
(I) a first mode of operation in which water is filtered via the non-electrical filtering chamber and the removable filtering capsule;
(II) a second mode of operation in which water is not filtered via the non-electrical filtering chamber and the removable filtering capsule.

13. The water faucet of claim 1, wherein the non-electrical filtering chamber comprises said cavity to accommodate said replaceable filtering capsule which further comprises at least one of:
a flavor-producing agent that adds a particular flavor to the water being filtered;
a scent-producing agent that adds a particular scent to the water being filtered;
a nutrient that is added to the water being filtered;
a dietary supplement that is added to the water being filtered.

14. An apparatus comprising:
a water-filtering capsule, that is insertable into and is removable from a non-electrical filtering chamber of a water faucet;
wherein the water-filtering capsule is replaceable, and operates to filter water that flow within said water faucet at a point that is vertically higher relative to a surface of a sink or a countertop on which said water faucet is connected.

15. The apparatus of claim 14, wherein the non-electrical filtering chamber and the water-filtering capsule operate and filter water without utilizing any electric power.

16. The apparatus of claim 14, wherein the water-filtering capsule comprises an active filtering component selected from the group consisting of: carbon, active charcoal.

17. The apparatus of claim 14, wherein the water-filtering capsule comprises a passive filtering component.

18. The apparatus of claim 14, wherein the water-filtering capsule comprises at least one of:
a flavor-producing agent that adds a particular flavor to the water being filtered;
a scent-producing agent that adds a particular scent to the water being filtered;
a nutrient that is added to the water being filtered;
a dietary supplement that is added to the water being filtered.

19. The apparatus of claim 14, wherein the water-filtering capsule integrally comprises an O-Ring to prevent water leakage; wherein the O-Ring and the water-filtering capsule are a single injected-molding article.
